(19) United States
(12) Patent Application Publication
(10) Pub. No.: US 2023/0015119 A1
(43) Pub. Date: Jan. 19, 2023

(54) MULTI-LOBE SEAL AND SEALING DEVICE COMPRISING SUCH A SEAL

(71) Applicant: PLASTIC OMNIUM ADVANCED INNOVATION AND RESEARCH, Bruxelles (BE)

(72) Inventors: Jean-Francois COING, Bruxelles (BE); Wilfried LEMASSON, Bruxelles (BE)

(73) Assignee: PLASTIC OMNIUM ADVANCED INNOVATION AND RESEARCH, Bruxelles (BE)

(21) Appl. No.: 17/780,878

(22) PCT Filed: Nov. 30, 2020
(86) PCT No.: PCT/EP2020/083854

§ 371 Date: May 27, 2022

(30) Foreign Application Priority Data
Nov. 29, 2019 (FR) 19 13565

(51) Int. Cl. F16J 15/06

(52) U.S. Cl. CPC F16J 15/06

(57) ABSTRACT

A multi-lobe seal for a sealing device for sealing an opening in a multi-layer wall of a fuel tank, the multi-layer wall having a layer of fuel barrier material and an opening in the multi-layer wall, the multi-lobe seal being fuel-impermeable and capable of being positioned in contact, at the opening in the multi-layer wall of the fuel tank, between the layer of fuel barrier material of the multi-layer wall of the fuel tank and a component, is disclosed. The multi-lobe seal includes, on the face capable of being in contact with the layer of fuel barrier material of the multi-layer wall, at least two protrusions, one of which leans on the layer of fuel barrier material of the multi-layer wall.

### TECHNICAL FIELD OF THE INVENTION

The invention relates to a multi-lobe seal and to a sealing device comprising such a seal for a motor vehicle fuel tank, as well as to a fuel tank comprising said sealing device. Specifically, the invention relates to a method for producing a sealing device for a motor vehicle fuel tank.

### TECHNICAL BACKGROUND OF THE INVENTION

To this end, fuel tanks of various types must generally meet the standards of impermeability and permeability depending on the type of use for which they are designed and the requirements in terms of environmental considerations that they must meet. Currently, in Europe and in the rest of the world, we are currently witnessing a considerable tightening of the requirements for limiting emissions and the spread of pollutants in the atmosphere and the environment in general.

Furthermore, allowable emission limits have become so low that losses associated with leakage and permeability at the interfaces between components and the tank are now responsible for a high proportion of the total losses in the system made up of the tank and accessories. Fuel tank design is therefore rapidly evolving toward techniques capable of better ensuring impermeability and environmental safety under varying usage conditions.

Consequently, fuel tanks located in particular on board a motor vehicle are connected to other components which are generally fuel-impermeable, requiring the presence of multiple openings in the multi-layer wall of the tank around which the components are fastened. The incorporation of components in these tanks poses the problem of fastening them, so as to be sealed and impermeable, to an opening made in these tanks. These openings, which create discontinuities in the barrier layer of the multi-layer wall of a fuel tank, represent a high risk of fuel leakage or permeation. The fact of having a multi-layer tank and a component each having a low level of permeability is not sufficient to ensure that the level of permeability at their mutual interface will also be low.

Thus, a sealing device can be used in particular for a fuel tank. To control fuel leakage, it is necessary to precisely know the fuel leakage paths around the opening defined by the space existing between a sealing device for a multi-layer wall of a fuel tank and the fuel barrier layer of the wall of a fuel tank.

However, since the precise position of the fuel barrier layer in the thickness of the tank wall is unknown, these permeation paths are not predetermined.

Consequently, the risks associated with fuel leaks have to be reduced in fuel tanks, in particular around the openings in the multi-layer wall of the fuel tank. These openings are one of the main sources of fuel leaks.

To solve this problem of permeability at the interfaces between the multi-layer tank and the component(s), various techniques for sealing a multi-layer tank are already known, such as from EP 0 838 360, US 2003/209905, FR 2 869 842 and EP 1 514 718. However, these solutions generally have the disadvantage of high cost and/or high permeability. Moreover, in the case of permanent fastening of the component to the tank, it is not possible to easily replace the component without damaging the sealing device itself.

In order to be able to solve this problem of permeability at the interfaces between the multi-layer wall of a fuel tank and the component(s), as well as the high assembly cost of the various sealing techniques, various sealing techniques have been proposed in the prior art, such as in US2013/0146595, which discloses a sealing means consisting of a seal in contact with the fuel barrier layer and a multi-layer wall of a fuel tank. Sealing is ensured by the fuel-impermeable seal which is resiliently pressed by the component against the wall, or by welding the seal to the component. Such an assembly has the disadvantage of having an extrusion on the multi-layer wall of the fuel tank, at the opening in the fuel tank, when the seal is resiliently pressed by the component against the multi-layer wall of the fuel tank. When the fuel tank is not extruded, the seal has to be welded to the multi-layer wall of the fuel tank, which allows the seal to be maintained. Consequently, the assembly processes are long and laborious; this increases the number of steps involved in producing a sealing means and thus increases the risks of leakage due to a large number of steps involved in producing the sealing means.

### SUMMARY OF THE INVENTION

The object of the invention is in particular to overcome these drawbacks of the prior art.

Another object of the invention, in at least one of its embodiments, is to provide a sealing device for a motor vehicle fuel tank which has improved fuel sealing properties at an opening in said tank fuel.

Specifically, an object of the invention, in at least one of its embodiments, is to provide a sealing device for a motor vehicle fuel tank which requires a reduced number of steps for producing said sealing device, thereby reducing the cost of producing said sealing device.

In addition, another object of the invention, in one of its embodiments, is to provide a motor vehicle fuel tank which comprises a sealing device for a motor vehicle fuel tank.

Another object of the invention, in at least one of its embodiments, is to implement a method for producing a sealing device for a motor vehicle fuel tank.

Thus, the invention relates to a multi-lobe seal for a sealing device for sealing an opening in a wall of a fuel tank, the wall of the multi-layer type having at least one layer of fuel barrier material and an opening in the multi-layer wall, the multi-lobe seal being fuel-impermeable and capable of being positioned in contact, at the opening in the multi-layer wall of the fuel tank, between the layer of fuel barrier material of the multi-layer wall of the fuel tank and a component, the multi-lobe seal comprising, on the face capable of being in contact with the layer of fuel barrier material of the multi-layer wall, at least two protrusions, one of which leans on the layer of fuel barrier material of the multi-layer wall.

The expression “multi-lobe seal” means a seal having multiple lobes or protrusions, unlike an O-ring seal which has a single lobe. In other words, a radial shaft seal or a lip seal.

Thus, the multi-lobe seal of the sealing device for a motor vehicle fuel tank will be limited in its movements for a longer period of time during the life phases of a motor vehicle fuel tank, i.e. changes within the fuel tank, for example in pressure or temperature. In addition, limiting the movements of the multi-lobe seal prevents the multi-lobe seal from falling into the fuel tank during the step of inserting the sealing device, and therefore provides a better seal around the opening in the multi-layer wall.

The expression “at least two protrusions” means that the multi-lobe seal has at least one protrusion positioned in contact with the layer of fuel barrier material and another protrusion adjacent to, or preferably two further protrusions on either side of, said protrusion in contact with the layer of fuel barrier material of the multi-layer wall.

The multi-lobe seal should have at least one protrusion positioned in contact with the layer of fuel barrier material and preferably two other protrusions on either side of said protrusion in contact with the layer of fuel barrier material of the multi-layer wall, since the exact position of the layer of fuel barrier material exposed by the opening in the multi-layer wall is unknown. Thus, a multi-lobe seal is required that is thick enough to rest firmly against the entire surface of the portion of the layer of fuel barrier material exposed in the opening.

As such, the multi-lobe seal of the sealing device for a motor vehicle fuel tank provides improved sealing around the opening in the multi-layer wall because the fuel leakage path around the opening is eliminated by close contact between the layer of fuel barrier material and the multi-lobe seal.

Advantageously, the multi-lobe seal can also comprise at least one shoulder which is intended to rest on an outer layer of a multi-layer wall of a fuel tank. Thus, limiting the movements of the multi-lobe seal prevents the multi-lobe seal from falling into the fuel tank and therefore ensures optimal sealing for a longer period of time during the life phases of a motor vehicle fuel tank.

According to the invention, a sealing device for an opening in a wall of a motor vehicle fuel tank comprises a wall of the multi-layer type having at least one layer of fuel barrier material and an opening in the multi-layer wall, and said device comprises: a component capable of being inserted into the opening in the multi-layer wall of the fuel tank; a multi-lobe seal as presented above capable of being positioned between the layer of fuel barrier material of the multi-layer wall of the fuel tank and the component; and a fastening element capable of being fastened to at least one outer layer of the multi-layer wall of the fuel tank.

The general principle of the invention is based on optimizing the sealing of a motor vehicle fuel tank, while reducing the number and complexity of the steps required to produce a sealing device for a motor vehicle fuel tank, thereby allowing a reduction in the cost of producing a sealing device for a motor vehicle fuel tank.

Thus, the invention is based on an entirely novel and inventive approach to producing a sealing device for a motor vehicle fuel tank, consisting of a component capable of being inserted into an opening in the multi-layer wall of the motor vehicle fuel tank, a fuel-impermeable multi-lobe seal capable of being positioned so as to be in contact with the multi-layer wall of the fuel tank and with the component inserted into the opening in the multi-layer wall of the fuel tank; and a fastening element capable of being fastened to at least one outer layer of the multi-layer wall of the fuel tank.

The expression “a multi-layer wall” means that the motor vehicle fuel tank comprises at least one layer of a plastic, preferably a thermoplastic, and at least one layer of fuel barrier material. Preferably, the multi-layer wall has two layers of a plastic and a layer of fuel barrier material. Said layers are positioned so that there is an upper layer of plastic material, a lower layer of plastic material and the layer of barrier material in the center of these two layers of plastic material. In other words, the layer of barrier material is sandwiched between the two layers of plastic material. The multiple layers of the fuel tank wall are fastened to each other when the multi-layer wall is formed by conforming the multi-layer wall to the shape of a mold, heating the materials of the multi-layer wall, allowing the materials of the multi-layer wall to fuse together at high temperature, and cooling them.

The plastic material for the motor vehicle fuel tank is a plastic material selected from the group of plastic materials based on polyoxymethylene (POM), polyphenylene sulfide (PPS), polyamide (PA) such as polyphthalamide (PPA), polyetheretherketone (PEEK), polyamide imide (PAI), polyaryletherketone (PAEK), polyketone (PK) or polyolefin, preferably polyethylene (PE), more preferably high-density polyethylene (HDPE).

The term “thermoplastic” means any thermoplastic polymer, including thermoplastic elastomers, as well as a mixture thereof.

The term “polymer” denotes both homopolymers and copolymers, in particular binary or ternary copolymers. Examples of such copolymers are random copolymers, linear block copolymers, other block copolymers and graft copolymers without limitation.

The expression “group of plastic materials based on” means that the plastic material comprises at least 50 wt. % of the selected plastic material.

The concepts of lower or upper are defined with respect to the final embodiment of the motor vehicle fuel tank. These concepts are defined by taking the center of the fuel tank as a reference, with a lower layer of the multi-layer wall being closer to the center of the fuel tank than an upper layer of the same wall.

The expression “layer of fuel barrier material” means the fuel-impermeable layer of the multi-layer wall. In other words, the layer allowing the sealing of the multi-layer wall with respect to fuels in liquid or gaseous form. Examples of barrier materials are resins based on polyamides or copolyamides, random ethylene/vinyl-alcohol copolymers, EVOH or thermotropic liquid crystal polymers, such as copolyesters of p-hydroxybenzoic acid and 6-hydroxy-2-naphthoic acid and copolyesters of p-hydroxybenzoic acid with terephthalic acid and 4,4′-biphenol. Preferably, the barrier material is ethylene vinyl alcohol.

The expression “a component” means any part obtained by a shaping technique such as blow molding or injection molding or any other technique known to a person skilled in the art. In particular, the part is shaped so that it can be inserted into an opening in a fuel tank and can compress the multi-lobe seal against the edge of the opening in the multi-layer wall.

The expression “the edge of the opening in the multi-layer wall” means the side of the multi-layer wall oriented toward the opening in the fuel tank, following the cutting of the multi-layer wall.

For this, a circular or non-circular opening is generally made in the multi-layer wall using any technique known to a person skilled in the art, such as: boring a hole through the multi-layer wall, pricking during blow-molding, i.e. generating the hole with the needle which is used to bore through the multi-layer wall at the end of the molding in order to release the gases, or generating a suitable geometry when blow-molding the hollow body. It has been observed that, surprisingly, a hole produced by pricking made it possible to obtain a flush barrier layer. If the technique used to make the opening in the multi-layer wall does not make it possible to obtain the desired geometry, the opening can then be machined.

The expression “an outer layer of the multi-layer wall” means a layer facing the outside of the tank, in contact with the external environment, unlike an inner layer, which will be facing the inside of the tank, in contact with the fuel.

The concepts of exterior or interior are defined with respect to the final embodiment of the motor vehicle fuel tank and are defined by taking the center of the fuel tank as a reference, with an inner layer of the multi-layer wall being closer to the center of the fuel tank than an outer layer of the same wall.

Thus, such a sealing device for a motor vehicle fuel tank makes it possible to obtain increased sealing with respect to fuel at the opening(s) in the multi-layer wall of a motor vehicle fuel tank, while allowing compression control of the multi-lobe seal during its assembly.

Advantageously, the sealing device for a motor vehicle fuel tank according to the invention is such that the multi-lobe seal has, on the face capable of being in contact with the component, a first connecting means resting on the component.

The expression “a first connecting means” means a specific connecting means between the component inserted into the opening in the multi-layer wall and the face of the multi-lobe seal oriented toward the component inserted into the opening in the multi-layer wall.

According to a preferred embodiment, such a sealing device for a motor vehicle fuel tank according to the invention is such that the multi-lobe seal is based on a material having a low fuel permeability, said material being selected from fluoroelastomers, and said material preferably being FPM.

The expression “low fuel permeability” means that the multi-lobe seal has a fuel permeability of less than 10 g·mm/m²·day, which allows it to be considered as fuel-impermeable. The permeability is measured according to the test procedure described in the SAE J 2665 standard where the test fuel is CE10 fuel which contains by volume 50% toluene, 50% isooctane and 10% ethanol, the test temperature is 40° C., the test pressure is atmospheric pressure and the test duration is the time required to reach equilibrium (stabilized emission regime). Note that the test duration varies according to the thickness of the sample.

The expression “based on material having a low fuel permeability” means that the multi-lobe seal comprises at least 50 wt. % of material having a low fuel permeability, preferably 75 wt. % of material having a low fuel permeability, more preferably 90 wt. % of material having a low fuel permeability.

Thus, the multi-lobe seal allows an optimization of the sealing of a motor vehicle fuel tank.

According to a preferred embodiment, such a sealing device for a motor vehicle fuel tank is such that the multi-lobe seal has, on the face capable of being in contact with the component, at least one projection leaning on the component.

The expression “at least one projection” means that the face of the multi-lobe seal capable of being in contact with the component has at least one protruding part by means of which the seal leans on the component.

Thus, the multi-lobe seal of the sealing device for a motor vehicle fuel tank has an additional zone of attachment with the component inserted into the opening in the multi-layer wall. Movements of the multi-lobe seal will be limited for a longer period of time during the life phases of a motor vehicle fuel tank. In addition, the multi-lobe seal will not be able to fall into the fuel tank during the step of inserting the sealing device, and therefore ensures improved sealing around the opening in the multi-layer wall.

According to a preferred embodiment, the sealing device for a motor vehicle fuel tank is such that the multi-lobe seal has a second connecting means resting on the multi-layer wall of the fuel tank.

The expression “a second connecting means” means a specific connecting means between the multi-layer wall and the face of the multi-lobe seal oriented toward the multi-layer wall.

Thus, limiting the movements of the multi-lobe seal prevents the multi-lobe seal from falling into the fuel tank and therefore ensures optimal sealing for a longer period of time during the life phases of a motor vehicle fuel tank.

According to a preferred embodiment, the sealing device for a motor vehicle fuel tank is such that the component and the multi-lobe seal are capable of exerting a radial pressure on the layer of fuel barrier material once the sealing device for a motor vehicle fuel tank has been assembled.

The expression “once the sealing device for a motor vehicle fuel tank has been assembled” means that the sealing device is in its final position. In other words, once all the parts of the sealing device are in place to perform their functions, i.e. the multi-lobe seal is positioned on the component, then the assembly is inserted into the opening. The dimensions of the multi-lobe seal and the component are such that they allow for a radial compression on the layer of fuel barrier material of the multi-layer wall, and also allow for the protrusion of the multi-lobe seal to be positioned in contact with the layer of fuel barrier material with preferably two other protrusions on either side of said protrusion in contact with the layer of fuel barrier material of the multi-layer wall. Next, a fastening element is fastened to the multi-layer wall to hold the multi-lobe seal device and component assembly together. Alternatively, the multi-lobe seal can be overmolded onto the component at the location at which it is intended to produce a multi-lobe seal and component assembly allowing for optimum sealing.

Similarly, the fastening element could be integral with the component, i.e. produced in one piece such as being made from the same material during casting or injection in order to further optimize the sealing. It is therefore clear that the component cannot be limited to a part that is hollow at its center.

Preferably, the multi-lobe seal is positioned in contact with the layer of fuel barrier material of the multi-layer wall of the fuel tank. Thus, the fact that the multi-lobe seal is in contact with the layer of fuel barrier material of the multi-layer wall of the motor vehicle fuel tank makes it possible to reduce gas or liquid leaks at the contact interface between the sealing device for a motor vehicle fuel tank and a motor vehicle fuel tank. The radial compression of the multi-lobe seal gives excellent results in terms of the reduction of permeability, since it makes it possible to reduce the distance between the multi-lobe seal and the layer of fuel barrier material. In addition, the compressed multi-lobe seal will be limited in its movements, which prevents it from falling into the fuel tank during the step of inserting the sealing device. The multi-lobe seal thus remains in place by the radial compression exerted by the component.

According to a preferred embodiment, the sealing device for a motor vehicle fuel tank according to the invention is such that the component which is inserted into the multi-layer wall comprises a plastic material, said plastic material being selected from plastic materials based on polyoxymethylene, polyphenylene sulfide, polyamide, polyphthalamide, polyetheretherketone, polyamide imide, polyaryletherketone, polyketone or polyolefin; preferably, said plastic material is polyoxymethylene.

According to a preferred embodiment, the sealing device for a motor vehicle fuel tank is such that the multi-lobe seal comprises at least one shoulder which is capable of being axially compressed by the component and rests on the multi-layer wall of a fuel tank.

The expression “shoulder” means a change in cross section of a part which, before the end, provides a face intended to serve as a support for another part, in other words, a protruding part allowing connection to another element by bearing on said other element.

Thus, the multi-lobe seal of the sealing device for a motor vehicle fuel tank provides improved sealing around the opening in the multi-layer wall. In addition, the compressed multi-lobe seal will not fall into the fuel tank during the stage of inserting the sealing device and limits the movement of the multi-lobe seal for a longer period of time during the life phases of a motor vehicle fuel tank.

According to a preferred embodiment, the sealing device for a motor vehicle fuel tank is such that the fastening element, when the opening in the multi-layer wall of a motor vehicle fuel tank is closed, is capable of being a solid part, and preferably said part is a disc.

The expression “the fastening element” means an element which is fastened to the multi-layer wall of a motor vehicle fuel tank and makes it possible to hold the other constituent elements of the sealing device for a motor vehicle fuel tank, namely the multi-lobe seal and the component. The fastening element is thus in contact with the component.

The expression “when the opening in the wall is closed” refers to the will of the manufacturer of the motor vehicle fuel tank to close the opening in the multi-layer wall.

The expression “a solid part” means that the part is made of a material whose material uses the entire volume of the part, and said part therefore does not have a void or opening.

Thus, such a fastening element makes it possible to provide the motor vehicle fuel tank with an increased resistance to pressure between the various constituent elements of the sealing device for a motor vehicle fuel tank. It also allows improved mechanical resistance to the pressures and various mechanical stresses to which the component and the multi-lobe seal are subjected. Furthermore, by limiting the possible movements of the component which is inserted into the opening in the multi-layer wall, and consequently the movements of the multi-lobe seal, by radial compression, this results in a limitation of the risk of fuel leakage at the interface between the multi-lobe seal and the layer of fuel barrier material of the multi-layer wall.

According to another embodiment, the sealing device for a motor vehicle fuel tank is such that the fastening element is based on plastic material, said plastic material being selected from plastic materials based on polyolefin, said plastic material preferably being high-density polyethylene, and said plastic material more preferably being filled high-density polyethylene.

The expression “filled high-density polyethylene” means high-density polyethylene filled with glass fibers or glass beads; these elements are given by way of example and are thus not limiting.

Thus, the fastening element provides the sealing device for a motor vehicle fuel tank with increased resistance to the various pressures and mechanical stresses to which the component and the multi-lobe seal are subjected.

According to a preferred embodiment, the sealing device for a motor vehicle fuel tank is such that the fastening element is fastened to the multi-layer wall of a fuel tank, said fastening means being selected from fastening methods such as welding, gluing, sintering and overmolding, and said connection is preferably made by welding.

When the means for fastening the sealing device for a motor vehicle fuel tank to said multi-layer wall is a weld, the plastic material selected will be a material that is chemically compatible with the plastic material constituting the multi-layer wall such as a polyolefin, preferably high-density polyethylene, more preferably filled high-density polyethylene.

A plastic material that is “chemically compatible” with another plastic material means that the plastic materials each comprise chemical species that can be welded together without requiring additional material. In other words, chemically compatible plastic materials are capable of bonding closely together by melting, and in particular of producing a molecular entanglement of their respective polymer chains. Welding the two plastic materials means bringing the two plastic materials into contact in such a way that the self-adhesion phenomenon occurs at the point of contact. The self-adhesion phenomenon occurs when heat is applied to the point of contact. An operation for welding two materials under the action of heat is called thermowelding. In the following, “welding” is used synonymously with “thermowelding.”

“Molecular entanglement of polymer chains” of one plastic material and another plastic material means two plastic materials pressed together in such a way that a self-adhesion phenomenon occurs. Self-adhesion of this kind is the phenomenon describing the intermolecular diffusion and entanglement of molecular chains across a polymer interface, resulting in a strong bond. Unlike adhesion, which concerns surface energy (or secondary chemical bonds between two materials that are either similar or not similar), self-adhesion concerns the entanglement of molecular chains and secondary bonds for polymer chains of similar materials, i.e. chemically compatible materials. Under ideal conditions, the diffusion is complete when the interface between the two polymer materials is no longer discernible from the bulk of each of the two polymer materials. For example, in the case of two thermoplastic polymer materials, once thermoplastic polymer to thermoplastic polymer contact is achieved at the interface, the intermolecular diffusion and entanglement is required to complete the process and produce a good weld. A self-adhesion phenomenon of this kind is described, for example, in the publication “Plastics and Composites Welding Handbook,” ISBN 1-56990-313-1, page 23.

Thus, the fastening means makes it possible to facilitate the method for producing the sealing device for a motor vehicle fuel tank, thus making it possible to reduce the cost of producing the sealing device for a motor vehicle fuel tank.

According to a preferred embodiment, the sealing device for a motor vehicle fuel tank is such that the fastening element, in the event of an exchange between the internal environment of the motor vehicle fuel tank and the external environment, is capable of being a part that is hollow at its center, and preferably said part is a ring.

The expression “in the event of an exchange” refers to the will of the manufacturer of the motor vehicle fuel tank to leave the opening in the multi-layer wall open in order to allow a sealed connection to other components.

The expression “a sealed connection to other components” means components other than the component of the sealing device which are inserted into the opening in the multi-layer wall, such that the component is capable of being, without limitation, a pipette, a nozzle, a neck, a valve, a measurement module base, a pump module base, an electrical connector or a sensor.

In particular, this connection allows fluid exchange to take place in the center of the opening, via the component that is hollow at its center, while maintaining the level of impermeability of the motor vehicle fuel tank. The permeation of fuel is prevented from the opening up to the end of the fastening element where other components are connected. This connection is made by any method known to a person skilled in the art.

Thus, the part that is hollow at its center allows the passage of a fluid at its center, such as air or fuel in the ebb and flow directions. Since a ring can be produced more easily, said ring thus reduces the associated production costs. In addition, the ring of the sealing device for a motor vehicle fuel tank allows for enhanced sealing, as well as easier assembly in the production of said sealing device for a motor vehicle fuel tank.

According to a preferred embodiment, the sealing device for a motor vehicle fuel tank is such that the fastening element is capable of being fastened on all of the areas in contact with the multi-layer wall of a fuel tank.

The expression “capable of being fastened on all of the areas in contact with the wall” means all the areas of possible contact between the fastening element and the multi-layer wall of a fuel tank.

Thus, the fastening element of the sealing device for a motor vehicle fuel tank can be fastened to the multi-layer wall without space limitation, thereby facilitating the method for obtaining the sealing device for a motor vehicle fuel tank, and thus reducing the cost of providing the sealing device for a motor vehicle fuel tank.

Another object of the invention is to provide a fuel tank comprising a sealing device for a motor vehicle fuel tank.

The invention also relates to a method for obtaining a fuel tank having a sealing device as presented above for motor vehicles, comprising at least the steps of:
positioning the multi-lobe seal in contact with the layer of fuel barrier material of the multi-layer wall of the fuel tank;
compressing the multi-lobe seal, by the component also inserted into the opening in the multi-layer wall of the fuel tank, against the layer of fuel barrier material of the multi-layer wall of the fuel tank;
fastening the fastening element to the multi-layer wall of the fuel tank, it being possible to select the fastening from different fastening methods such as welding, gluing, sintering, and overmolding, and said fastening is preferably made by welding.

Thus, the steps for producing a sealing device for a motor vehicle fuel tank are facilitated and reduced, resulting in a reduction in the cost of producing said sealing device for a motor vehicle fuel tank.

### BRIEF DESCRIPTION OF THE DRAWINGS

Other features and advantages of the invention will become clear on reading the following description of a preferred embodiment, given merely as an illustrative and non-limiting example, and the appended drawings, in which:

FIG. 1 shows a motor vehicle fuel tank provided with an opening according to the invention;

FIG. 2 is a cross section of part of the multi-lobe seal according to the invention;

FIG. 3 shows a sealing device for a motor vehicle fuel tank according to the invention;

FIG. 4 describes a sealing device for a motor vehicle fuel tank, when the opening in the motor vehicle fuel tank according to the invention shown in FIG. 3 is closed;

FIG. 5 shows another embodiment of the sealing device for a motor vehicle fuel tank, in which a connection component is connected to a motor vehicle fuel tank according to the invention;

FIG. 6 shows an alternative embodiment of the sealing device for a motor vehicle fuel tank, in which the second connecting means is a shoulder;

FIG. 7 shows a view of an embodiment of the sealing device for a motor vehicle fuel tank, in which the face of the multi-lobe seal oriented toward the component has a projection.

### DETAILED DESCRIPTION OF AT LEAST ONE EMBODIMENT OF THE INVENTION

The following embodiments are examples. Although the description refers to one or more embodiments, this does not necessarily mean that each reference is to the same embodiment, or that the features apply only to a single embodiment. Simple features of different embodiments may also be combined and/or interchanged to provide other embodiments.

In the present description, it is possible to index certain elements or parameters, for example a first element or second element as well as a first parameter and second parameter or a first criterion and second criterion, etc. In this case, it is a simple indexing process to differentiate and name similar but not identical elements or parameters or criteria. This indexing does not imply a priority of one element, parameter or criterion with respect to another and such denominations can easily be interchanged without departing from the scope of the present description. Nor does this indexing imply an order in time, for example to assess this or that criterion.

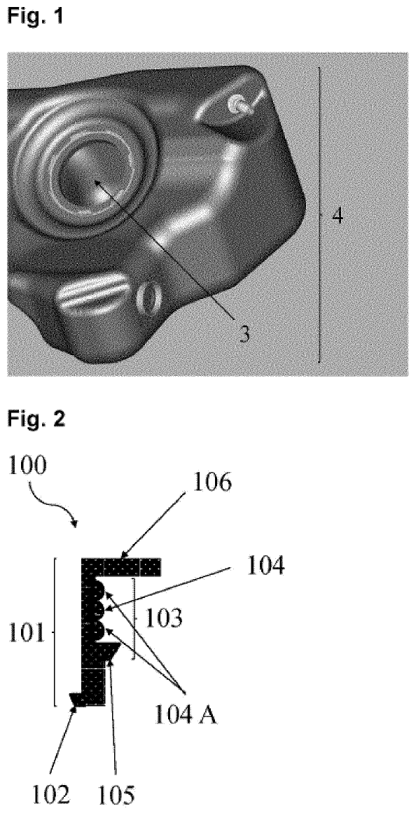

In relation to FIG. 1, a motor vehicle fuel tank (4) is presented. The motor vehicle fuel tank (4) has an opening (3) capable of receiving the sealing device (1) for a motor vehicle fuel tank (4) according to the invention, said sealing device (1) not being shown in FIG. 1.

FIG. 2 is a cross section of an embodiment of the multi-lobe seal (100) according to the invention, and said multi-lobe seal (100) is fuel-impermeable. The multi-lobe seal (100) is based on a material having a low fuel permeability, said material being FPM. The multi-lobe seal (100) according to the invention consists of a face (101) capable of being oriented toward a component (2) capable of being inserted into the opening (3) in the multi-layer wall (10) of the motor vehicle fuel tank (4). Said face (101) comprises a first connecting means (102) resting on said component (2). The multi-lobe seal (100) also comprises a face (103) capable of being oriented toward the edge of a multi-layer wall (10) of a motor vehicle fuel tank (4). Said face (103) capable of being oriented toward the edge of the multi-layer wall (10) consists of a protrusion (104) capable of being in contact (11A) with the layer (11) of fuel barrier material of the multi-layer wall (10) of a motor vehicle fuel tank (4). Said protrusion (104) is surrounded on either side by protrusions (104A) capable of being in contact with the multi-layer wall (10) of the motor vehicle fuel tank (4). In addition, the multi-lobe seal (100) has, on said face (103) capable of being oriented toward the edge of a multi-layer wall (10) of a motor vehicle fuel tank (4), a second connecting means (105) capable of leaning on the multi-layer wall (10) of a motor vehicle fuel tank (4). Finally, the multi-lobe seal (100) consists of a shoulder (106) covering the multi-lobe seal (100). Said shoulder (106) is capable of being in contact with the outer layer (12) of the multi-layer wall (10) and said component (2). The multi-layer wall (10) of the motor vehicle fuel tank (4), the component (2) capable of being inserted into the opening (3) in the multi-layer wall (10) and the opening (3) in the multi-layer wall (10) are not shown in FIG. 2.

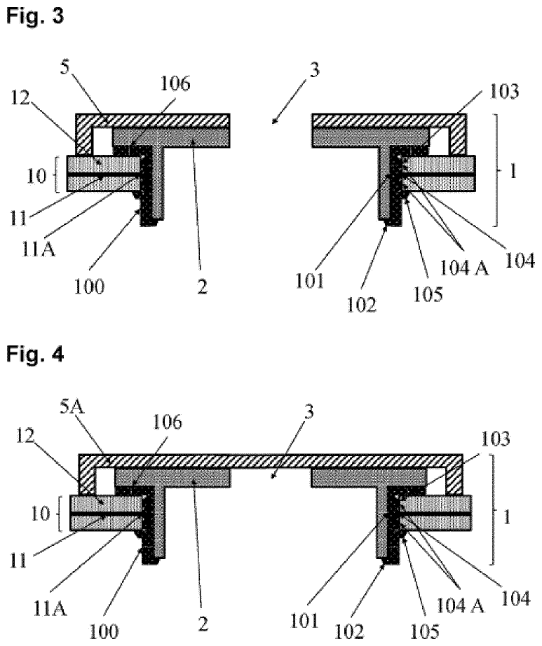

FIG. 3 is a cross section of the sealing device (1) for a motor vehicle fuel tank (4) according to the invention. It can be seen that the sealing device (1) for a motor vehicle fuel tank (4) comprises a multi-layer wall (10) having a layer (11) of fuel barrier material, as well as an opening (3) in the multi-layer wall (10) in which a fuel-impermeable multi-lobe seal (100) is inserted which is made of FPM, and a component (2) which is inserted so as to exert a radial compression on the multi-lobe seal (100). The compressed multi-lobe seal (100) in turn exerts a radial compression on the multi-layer wall (10) of a motor vehicle fuel tank (4) once the sealing device (1) for a motor vehicle fuel tank (4) has been assembled. The multi-lobe seal (100) and component (2) assembly, inserted into the opening (3) in the multi-layer wall (10), is held by fastening a fastening element (5) to the outer layer (12) of the multi-layer wall (10), with said fastening being a weld. The fastening of the fastening element (5) exerts an axial compression on the component (2) located between the multi-lobe seal (100) and the fastening element (5). Said component (2) then in turn exerts an axial compression on the shoulder (106) of the multi-lobe seal (100), which rests on the outer layer (12) of the multi-layer wall (10) of the motor vehicle fuel tank (4). The multi-lobe seal (100) consists of a face (101) oriented toward a component (2). Said face (101) comprises a first connecting means (102) resting on said component (2). The multi-lobe seal (100) also comprises a face (103) oriented toward the edge of a multi-layer wall (10) of a motor vehicle fuel tank (4). Said face (103) oriented toward the edge of the multi-layer wall (10) consists of a protrusion (104) in contact (11A) with the layer (11) of fuel barrier material of the multi-layer wall (10) of a motor vehicle fuel tank (4). Said protrusion (104) is surrounded on either side by protrusions (104A) in contact with the multi-layer wall (10) of the motor vehicle fuel tank (4). In addition, the multi-lobe seal (100) has, on said face (103) oriented toward the edge of a multi-layer wall (10) of a motor vehicle fuel tank (4), a second connecting means (105) capable of leaning on the multi-layer wall (10) of a motor vehicle fuel tank (4). The multi-lobe seal (100) consists of a shoulder (106) covering the multi-lobe seal (100). Said shoulder (106) is in contact with the outer layer (12) of the multi-layer wall (10) and said component (2).

FIG. 4 is a cross section of a second embodiment of a sealing device (1) for a motor vehicle fuel tank (4) according to the invention shown in FIG. 3. It can be seen that the sealing device (1) for a motor vehicle fuel tank (4) comprises a multi-layer wall (10) having a layer (11) of fuel barrier material, as well as an opening (3) in the multi-layer wall (10) in which a fuel-impermeable multi-lobe seal (100) is inserted which is made of FPM, and a component (2) which is inserted so as to exert a radial compression on the multi-lobe seal (100). The compressed multi-lobe seal (100) in turn exerts a radial compression on the multi-layer wall (10) of a motor vehicle fuel tank (4) once the sealing device (1) for a motor vehicle fuel tank (4) has been assembled. The multi-lobe seal (100) and component (2) assembly, inserted into the opening (3) in multi-layer wall (10), is held by fastening a fastening element (5A) to the outer layer (12) of the multi-layer wall (10), with said fastening being a weld. The fastening of the fastening element (5A) exerts an axial compression on the component (2) located between the multi-lobe seal (100) and the fastening element (5A). In this particular embodiment, the fastening element (5A) is a solid part which closes the opening (3) in the multi-layer wall (10) of the motor vehicle fuel tank (4). Said component (2) then in turn exerts an axial compression on the shoulder (106) of the multi-lobe seal (100), which rests on the outer layer (12) of the multi-layer wall (10) of the motor vehicle fuel tank (4). The multi-lobe seal (100) consists of a face (101) oriented toward a component (2). Said face (101) comprises a first connecting means (102) resting on said component (2). The multi-lobe seal (100) also comprises a face (103) oriented toward the edge of a multi-layer wall (10) of a motor vehicle fuel tank (4). Said face (103) oriented toward the edge of the multi-layer wall (10) consists of a protrusion (104) in contact (11A) with the layer (11) of fuel barrier material of the multi-layer wall (10) of a motor vehicle fuel tank (4). Said protrusion (104) is surrounded on either side by protrusions (104A) in contact with the multi-layer wall (10) of the motor vehicle fuel tank (4). In addition, the multi-lobe seal (100) has, on said face (103) oriented toward the edge of a multi-layer wall (10) of a motor vehicle fuel tank (4), a second connecting means (105) capable of leaning on the multi-layer wall (10) of a motor vehicle fuel tank (4). Finally, the multi-lobe seal (100) consists of a shoulder (106) covering the multi-lobe seal (100). Said shoulder (106) is in contact with the outer layer (12) of the multi-layer wall (10) and said component (2).

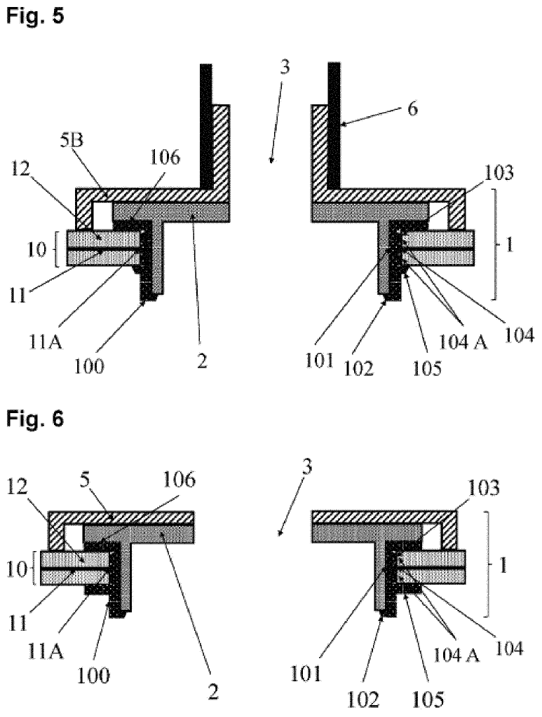

FIG. 5 is a cross section of a third embodiment of the sealing device (1) for a motor vehicle fuel tank (4) according to the invention shown in FIG. 3. It can be seen that the sealing device (1) for a motor vehicle fuel tank (4) comprises a multi-layer wall (10) having a layer (11) of fuel barrier material, as well as an opening (3) in the multi-layer wall (10) in which a fuel-impermeable multi-lobe seal (100) is inserted which is made of FPM, and a component (2) which is inserted so as to exert a radial compression on the multi-lobe seal (100). The compressed multi-lobe seal (100) in turn exerts a radial compression on the multi-layer wall (10) of a motor vehicle fuel tank (4) once the sealing device (1) for a motor vehicle fuel tank (4) has been assembled. The multi-lobe seal (100) and component (2) assembly, inserted into the opening (3) in multi-layer wall (10), is held by fastening a fastening element (5B) to the outer layer (12) of the multi-layer wall (10), with said fastening being a weld. The fastening of the fastening element (5B) exerts an axial compression on the component (2) located between the multi-lobe seal (100) and the fastening element (56). In this particular embodiment, the fastening element (5B) is a part that is hollow at its center and allows the connection to other components (6) having a low fuel permeability. Said component (2) then in turn exerts an axial compression on the shoulder (106) of the multi-lobe seal (100), which rests on the outer layer (12) of the multi-layer wall (10) of the motor vehicle fuel tank (4). The multi-lobe seal (100) consists of a face (101) oriented toward a component (2). Said face (101) comprises a first connecting means (102) resting on said component (2). The multi-lobe seal (100) also comprises a face (103) oriented toward the edge of a multi-layer wall (10) of a motor vehicle fuel tank (4). Said face (103) oriented toward the edge of the multi-layer wall (10) consists of a protrusion (104) in contact (11A) with the layer (11) of fuel barrier material of the multi-layer wall (10) of a motor vehicle fuel tank (4). Said protrusion (104) is surrounded on either side by protrusions (104A) in contact with the multi-layer wall (10) of the motor vehicle fuel tank (4). In addition, the multi-lobe seal (100) has, on said face (103) oriented toward the edge of a multi-layer wall (10) of a motor vehicle fuel tank (4), a second connecting means (105) capable of leaning on the multi-layer wall (10) of a motor vehicle fuel tank (4). Finally, the multi-lobe seal (100) consists of a shoulder (106) covering the multi-lobe seal (100). Said shoulder (106) is in contact with the outer layer (12) of the multi-layer wall (10) and said component (2).

FIG. 6 is a cross section of an alternative embodiment of the sealing device (1) for a motor vehicle fuel tank (4) according to the invention. It can be seen that the sealing device (1) for a motor vehicle fuel tank (4) comprises a multi-layer wall (10) having a layer (11) of fuel barrier material, as well as an opening (3) in the multi-layer wall (10) in which a fuel-impermeable multi-lobe seal (100) is inserted which is made of FPM, and a component (2) which is inserted so as to exert a radial compression on the multi-lobe seal (100). The compressed multi-lobe seal (100) in turn exerts a radial compression on the multi-layer wall (10) of a motor vehicle fuel tank (4) once the sealing device (1) for a motor vehicle fuel tank (4) has been assembled. The multi-lobe seal (100) and component (2) assembly, inserted into the opening (3) in multi-layer wall (10), is held by fastening a fastening element (5) to the outer layer (12) of the multi-layer wall (10), with said fastening being a weld. The fastening of the fastening element (5) exerts an axial compression on the component (2) located between the multi-lobe seal (100) and the fastening element (5). Said component (2) then in turn exerts an axial compression on the shoulder (106) of the multi-lobe seal (100), which rests on the outer layer (12) of the multi-layer wall (10) of the motor vehicle fuel tank (4). The multi-lobe seal (100) consists of a face (101) oriented toward a component (2). Said face (101) comprises a first connecting means (102) resting on said component (2). The multi-lobe seal (100) also comprises a face (103) oriented toward the edge of a multi-layer wall (10) of a motor vehicle fuel tank (4). Said face (103) oriented toward the edge of the multi-layer wall (10) consists of a protrusion (104) in contact (11A) with the layer (11) of fuel barrier material of the multi-layer wall (10) of a motor vehicle fuel tank (4). Said protrusion (104) is surrounded on either side by protrusions (104A) in contact with the multi-layer wall (10) of the motor vehicle fuel tank (4). In addition, the multi-lobe seal (100) has, on said face (103) oriented toward the edge of a multi-layer wall (10) of a motor vehicle fuel tank (4), a second connecting means (105) capable of leaning on the multi-layer wall (10) of a motor vehicle fuel tank (4). In this particular embodiment, the second connecting means (105) is a second shoulder resting on the multi-layer wall (10). The multi-lobe seal (100) consists of a shoulder (106) covering the multi-lobe seal (100). Said shoulder (106) is in contact with the outer layer (12) of the multi-layer wall (10) and said component (2).

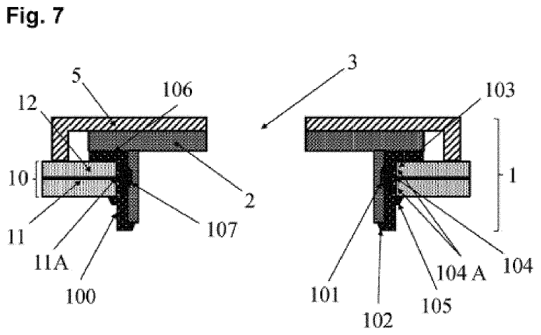

FIG. 7 describes a cross section of the sealing device (1) for a motor vehicle fuel tank (4) according to the invention. It can be seen that the sealing device (1) for a motor vehicle fuel tank (4) comprises a multi-layer wall (10) having a layer (11) of fuel barrier material, as well as an opening (3) in the multi-layer wall (10) in which a fuel-impermeable multi-lobe seal (100) is inserted which is made of FPM, and a component (2) which is inserted so as to exert a radial compression on the multi-lobe seal (100). The compressed multi-lobe seal (100) in turn exerts a radial compression on the multi-layer wall (10) of a motor vehicle fuel tank (4) once the sealing device (1) for a motor vehicle fuel tank (4) has been assembled. The multi-lobe seal (100) and component (2) assembly, inserted into the opening (3) in the multi-layer wall (10), is held by fastening a fastening element (5) to the outer layer (12) of the multi-layer wall (10), with said fastening being a weld. The fastening of the fastening element (5) exerts an axial compression on the component (2) located between the multi-lobe seal (100) and the fastening element (5). Said component (2) then in turn exerts an axial compression on the shoulder (106) of the multi-lobe seal (100), which rests on the outer layer (12) of the multi-layer wall (10) of the motor vehicle fuel tank (4). The multi-lobe seal (100) consists of a face (101) oriented toward a component (2). Said face (101) comprises a first connecting means (102) resting on said component (2) and, in this particular embodiment, a projection (107) leaning on the component (2). The multi-lobe seal (100) also comprises a face (103) oriented toward the edge of a multi-layer wall (10) of a motor vehicle fuel tank (4). Said face (103) oriented toward the edge of the multi-layer wall (10) consists of a protrusion (104) in contact (11A) with the layer (11) of fuel barrier material of the multi-layer wall (10) of a motor vehicle fuel tank (4). Said protrusion (104) is surrounded on either side by protrusions (104A) in contact with the multi-layer wall (10) of the motor vehicle fuel tank (4). In addition, the multi-lobe seal (100) has, on said face (103) oriented toward the edge of a multi-layer wall (10) of a motor vehicle fuel tank (4), a second connecting means (105) capable of resting on the multi-layer wall (10) of a motor vehicle fuel tank (4). Finally, the multi-lobe seal (100) consists of a shoulder (106) covering the multi-lobe seal (100). Said shoulder (106) is in contact with the outer layer (12) of the multi-layer wall (10) and said component (2).

1. A multi-lobe seal for a sealing device for sealing an opening in a wall of a fuel tank, the wall of the multi-layer type having at least one layer of fuel barrier material and an opening in the multi-layer wall, the multi-lobe seal being fuel-impermeable and capable of being positioned in contact, at the opening in the multi-layer wall of the fuel tank, between the layer of fuel barrier material of the multi-layer wall of the fuel tank and a component,
wherein the multi-lobe seal comprises, on the face capable of being in contact with the layer of fuel barrier material of the multi-layer wall at least two protrusions, one of which leans on the layer of fuel barrier material of the multi-layer wall.

2. The multi-lobe seal according to claim 1, comprising, on the face capable of being in contact with the layer of fuel barrier material of the multi-layer wall a protrusion leaning on the layer of fuel barrier material, and two other protrusions on either side of the protrusion leaning on the layer of fuel barrier material of the multi-layer wall.

3. The multi-lobe seal (100) according to claim 1, further comprising at least one shoulder intended to rest on an outer layer of the multi-layer wall of a fuel tank.

4. A sealing device for an opening in a wall of a motor vehicle fuel tank, the wall of the multi-layer type having at least one layer of fuel barrier material and an opening in the multi-layer wall, wherein said device comprises:
a component capable of being inserted into the opening in the multi-layer wall of the fuel tank;
a multi-lobe seal according to claim 1 capable of being positioned between the layer of fuel barrier material of the multi-layer wall of the fuel tank and the component; and
a fastening element capable of being fastened to at least one outer layer of the multi-layer wall of the fuel tank.

5. The sealing device for a fuel tank according to claim 4, such that the multi-lobe seal has, on the face capable of being in contact with the component, a first connecting means resting on the component.

6. The sealing device for a fuel tank according to claim 4, such that the multi-lobe seal has, on the face capable of being in contact with the layer of fuel barrier material of the multi-layer wall, a second connecting means resting on the multi-layer wall of the fuel tank.

7. The sealing device for a fuel tank according to claim 4, such that the component and the multi-lobe seal are capable of exerting a radial pressure on the layer of fuel barrier material once the sealing device for a motor vehicle fuel tank has been assembled.

8. The sealing device for a fuel tank according to claim 4, such that the fastening element is capable of being a solid part.

9. The sealing device for a fuel tank according to claim 4, such that the fastening element is capable of being a part that is hollow at its center.

10. The sealing device for a fuel tank according to claim 4, such that the fastening element is capable of being fastened on all of the areas in contact with the multi-layer wall of a fuel tank.

11. The sealing device for a fuel tank according to claim 4, such that the multi-lobe seal is overmolded onto the component.

12. The sealing device for a fuel tank according to claim 4, such that the fastening element is integral with the component.

13. A fuel tank comprising the sealing device according to claim 4.

14. A method for producing a fuel tank according to claim 13 comprising at least the steps of:
positioning the multi-lobe seal in contact with the layer of fuel barrier material of the multi-layer wall of the fuel tank;
compressing the multi-lobe seal, by the component also inserted into the opening in the multi-layer wall of the fuel tank, against the layer of fuel barrier material of the multi-layer wall of the fuel tank;
fastening the fastening element to the multi-layer wall of the fuel tank.

15. The method according to claim 14, such that the fastening of the fastening element is selected from welding, gluing, sintering and overmolding.
